(19) United States
(12) Patent Application Publication
(10) Pub. No.: US 2015/0006569 A1
(43) Pub. Date: Jan. 1, 2015

(54) METHOD AND APPARATUS FOR PREPARING DISASTER ALERT NOTICE REPORT

(71) Applicants: James WARNER, Sycamore Valley, OH (US); Daniel Studeny, McKees Rocks, PA (US)

(72) Inventors: James WARNER, Sycamore Valley, OH (US); Daniel Studeny, McKees Rocks, PA (US)

(21) Appl. No.: 14/318,101

(22) Filed: Jun. 27, 2014

Related U.S. Application Data
(60) Provisional application No. 61/840,879, filed on Jun. 28, 2013.

(51) Int. Cl. G06F 17/30

(52) U.S. Cl. CPC G06F 17/30241; G06F 17/30424
USPC 707/769

(57) ABSTRACT

The invention relates to method and apparatus for preparing a disaster alert notice report pertaining to possible damage to selected property. In particular, aspects of the present invention are directed to a method, system and compute program product for preparing a disaster alert notice report, which includes receiving a disaster inquiry comprising location information for at least one property and a date range having a start date and an end date, standardizing the location information for the at least one property to produce a geographic area for the at least one property, searching a disaster database for at least one disaster occurring between the start date and the end date of the date range and within the geographic area for the at least one property, and providing the disaster alert notice report identifying any disasters occurring within the date range and the geographic area for the at least one property.

### CROSS-REFERENCE TO RELATED APPLICATIONS

This application claims priority to U.S. Provisional Appl. No. 61/840,879 filed Jun. 28, 2013, which is hereby incorporated by reference in its entirety.

### FIELD OF THE INVENTION

The invention herein relates to method and apparatus for preparing a disaster alert notice report pertaining to possible damage to selected property, and more particularly to maintaining a disaster database and providing the disaster alert notice report based upon an inquiry of the disaster database.

### BACKGROUND OF THE INVENTION

Companies such as mortgage lenders, real estate investors, and insurance companies have an inherent interest in severe weather, disasters, whether natural or man-made, and essentially any event that could potentially damage real estate property in which they have or may have a financial interest. For those companies, which operate in a wide geographic footprint, tracking these events or even noticing them is nearly impossible. Some companies reference FEMA declared disasters to discover if their properties are in a disaster area, however that process is severely lacking for the following reasons:
1. If the disaster is not big enough it will not be declared by FEMA causing the company to not realize that their property has sustained potential damage.
   a. The disaster declaration has to be requested by the state governor and the disaster must be severe. Per FEMA, “. . . The disaster is of such severity and magnitude that effective response is beyond the capabilities of the State and the local governments and that Federal assistance is necessary.”
2. Disasters are not always declared immediately after they occur. For a company closing a mortgage loan on a property in a potential disaster area, these announcements may come way too late.
   a. Disasters can cause a large financial burden on a company who has to have onsite inspections to determine if a disaster in declared counties actually affected their property.

Accordingly, there is a need for a more thorough, geographically precise and expedient alert of events, such as disasters, that could damage a property at a particular location in which a company may have an interest in.

### SUMMARY OF THE INVENTION

The invention herein relates to method and apparatus for preparing a disaster alert notice report pertaining to possible damage to selected property, and more particularly to maintaining a disaster database and providing the disaster alert notice report based upon an inquiry of the disaster database. A disaster alert notice report can be provided as a one-time review and/or as a continual monitoring of disasters over a specified time period in a geographic area including the given property address. For one time review, properties are entered and a date range is selected. A disaster database is searched for disasters that have occurred in a geographic area including the selected property address(es). A disaster notice report is generated by the provider with information on any disasters that have potentially affected a selected property address during the specified date range. For continual monitoring, selected property addresses are continually re-run through the disaster database in order to capture any new disasters that could potentially affect them. Disaster alert notice reports are provided to the user whenever a disaster occurs that could potentially affect any of the selected property addresses. The disaster alert notice system will reference the specified property address, assign a geographic code for that address and then cross reference both address and geo-coded coordinates against the disaster areas in the disaster database. If the address is found to be within a disaster area during the specified date range, it will trigger a “match” and the disaster details will be provided in a disaster alert notice report.

In accordance with an exemplary embodiment of the present invention a method for indicating disasters affecting at least one property is provided, which may include receiving a disaster inquiry comprising location information for the at least one property and a date range having a start date and an end date, standardizing the location information for the at least one property to produce a geographic area for the at least one property, searching a disaster database for at least one disaster occurring between the start date and the end date of the date range and within the geographic area for the at least one property, and providing the disaster alert notice report identifying any disasters occurring within the date range and the geographic area for the at least one property.

In accordance with the exemplary method according to the present invention, the disaster database may be searched at regularly scheduled intervals for at least one disaster occurring between the start date and the end date of the date range and within the geographic area for the at least one property, and the disaster alert notice report is provided at regularly scheduled intervals for disasters occurring within the date range and the geographic area for the at least one property.

In accordance with the exemplary method according to the present invention, the disaster database may include at least one disaster selected from hurricanes, tornadoes, hail, high winds, flooding, fires, volcanic eruptions, explosions, earthquakes, tsunamis, chemical spills, any other events that may damage property or any combination thereof and a disaster area associated with each of the at least one disasters.

In accordance with the exemplary method according to the present invention, the disaster alert notice report may include the location information for the at least one property, the geographic area for the at least one property, a latitude and longitude coordinate for the at least one property, a date identifier for the disaster alert notice report, the date range, an identification for each disaster identified in the disaster alert notice report and Federal Emergency Management Agency information for each disaster identified in the disaster alert notice report.

In accordance with the exemplary method according to the present invention, the disaster database may include a collection of disasters, and the method may also include compiling the collection of disasters by adding each disaster to the collection of disasters, and wherein the disaster database includes a disaster type, a disaster name, a start date, an end date, press coverage, a disaster area and Federal Emergency Management Agency information for each disaster of the collection of disasters.

In accordance with the exemplary method according to the present invention, the disaster area associated with each of the at least one disasters is a geographic identifier selected from a city/town, a zip code, a county, a state, contiguous combinations thereof, a disaster perimeter comprised of multiple latitude and longitude coordinates, a distance diameter applied to a specific latitude and longitude coordinate or any combination thereof.

In accordance with the exemplary method according to the present invention, the identification for each disaster comprises a disaster type, a disaster name, a disaster summary, press coverage of the disaster, a disaster start date and a disaster end date.

In accordance with the exemplary method according to the present invention, the Federal Emergency Management Agency information for each disaster comprises a disaster area, a disaster date range comprising a disaster start date and a disaster end date and a disaster declaration date.

In accordance with the exemplary method according to the present invention, the method may also include adding an additional disaster to the collection of disasters of the disaster database.

In accordance with the exemplary method according to the present invention, the method may also include providing either an active indication or an inactive indication for each disaster of the collection of disasters, wherein only disasters having an active indication are searched for between the start date and the end date of the date range and within the geographic area for the at least one property.

In accordance with an exemplary embodiment of the present invention an apparatus for indicating disasters affecting at least one property is provided that may include at least one processor and at least one memory including computer program code, where the at least one memory and the computer program code are configured to with the at least one processor to cause the apparatus to receive a disaster inquiry comprising location information for the at least one property and a date range having a start date and an end date, standardize the location information for the at least one property to produce a geographic area for the at least one property, search a disaster database for at least one disaster occurring between the start date and the end date of the date range and within the geographic area for the at least one property, and provide the disaster alert notice report identifying any disasters occurring within the date range and the geographic area for the at least one property.

In accordance with the exemplary apparatus according to the present invention, the disaster database may be searched at regularly scheduled intervals for at least one disaster occurring between the start date and the end date of the date range and within the geographic area for the at least one property, and the disaster alert notice report may be provided at regularly scheduled intervals for disasters occurring within the date range and the geographic area for the at least one property.

In accordance with an exemplary embodiment of the present invention, the disaster database may include at least one disaster selected from hurricanes, tornadoes, hail, high winds, flooding, fires, volcanic eruptions, explosions, earthquakes, tsunamis, chemical spills, any other events that may damage property or any combination thereof and a disaster area associated with each of the at least one disasters.

In accordance with an exemplary embodiment of the present invention, the disaster area associated with each of the at least one disasters is a geographic identifier selected from a city/town, a zip code, a county, a state, contiguous combinations thereof, a disaster perimeter comprised of multiple latitude and longitude coordinates, a distance diameter applied to a specific latitude and longitude coordinate or any combination thereof.

In accordance with an exemplary embodiment of the present invention, the disaster alert notice report may include the location information for the at least one property, the geographic area for the at least one property, a latitude and longitude coordinate for the at least one property, a date identifier for the disaster alert notice report, the date range, an identification for each disaster identified in the disaster alert notice report and Federal Emergency Management Agency information for each disaster identified in the disaster alert notice report.

In accordance with an exemplary embodiment of the present invention, the identification for each disaster comprises a disaster type, a disaster name, a disaster summary, press coverage of the disaster, a disaster start date and a disaster end date.

In accordance with an exemplary embodiment of the present invention, the Federal Emergency Management Agency information for each disaster comprises a disaster area, a disaster date range including a disaster start date and a disaster end date and a disaster declaration date.

In accordance with an exemplary embodiment of the present invention, the disaster database may include a collection of disasters, and the at least one memory and the computer program code are configured to with the at least one processor to further cause the apparatus to compile the collection of disasters by adding each disaster to the collection of disasters, and wherein the disaster database includes a disaster type, a disaster name, a start date, an end date, press coverage, a disaster area and Federal Emergency Management Agency information for each disaster of the collection of disasters.

In accordance with an exemplary embodiment of the present invention, the at least one memory and the computer program code are configured to with the at least one processor to further cause the apparatus to add an additional disaster to the collection of disasters of the disaster database.

In accordance with an exemplary embodiment of the present invention, the at least one memory and the computer program code are configured to with the at least one processor to further cause the apparatus to provide either an active indication or an inactive indication for each disaster of the collection of disasters, wherein only disasters having an active indication are searched for between the start date and the end date of the date range and within the geographic area for the at least one property.

### BRIEF DESCRIPTION OF THE DRAWINGS

For a fuller understanding of the nature and object of the present invention, reference should be had to the following detailed description taken in connection with the accompanying drawings, in which:

FIG. 1 is a flowchart showing an exemplary method according to the present invention;

FIG. 2 is an exemplary disaster alert notice report that may be prepared according to the present invention;

FIG. 3 is another exemplary disaster alert notice report that may be prepared according to the present invention;

FIG. 4 is a flowchart showing an exemplary method of compiling and/or updating a disaster database in accordance with the present invention;

FIG. 5 is a flowchart with exemplary components that may be used to carry out an exemplary method according to the present invention;

FIG. 6 is a flowchart with exemplary components that may be used to carry out an exemplary method according to the present invention;

FIG. 7A is a representation of an exemplary disaster area according to the present invention; and

FIG. 7B is a representation of the exemplary disaster area with a subject property identified within the disaster area according to the present invention.

### DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

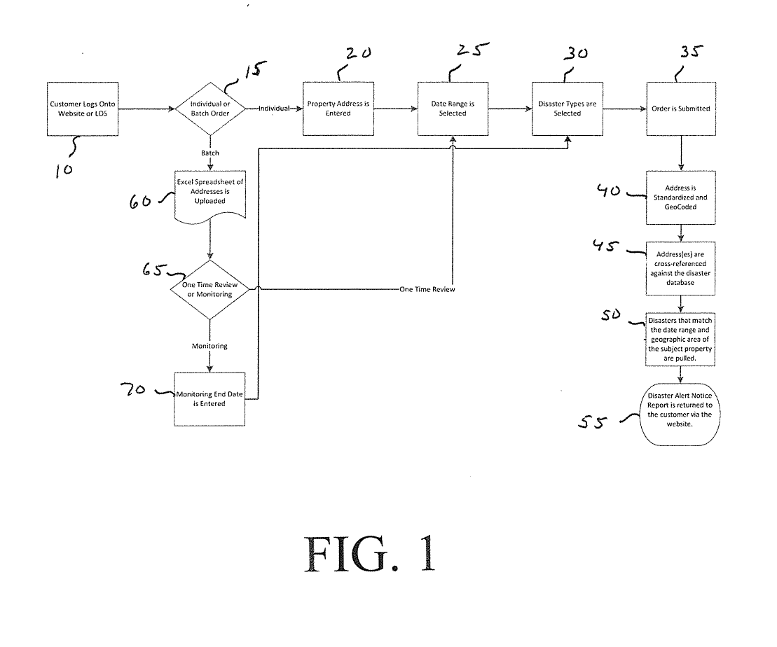

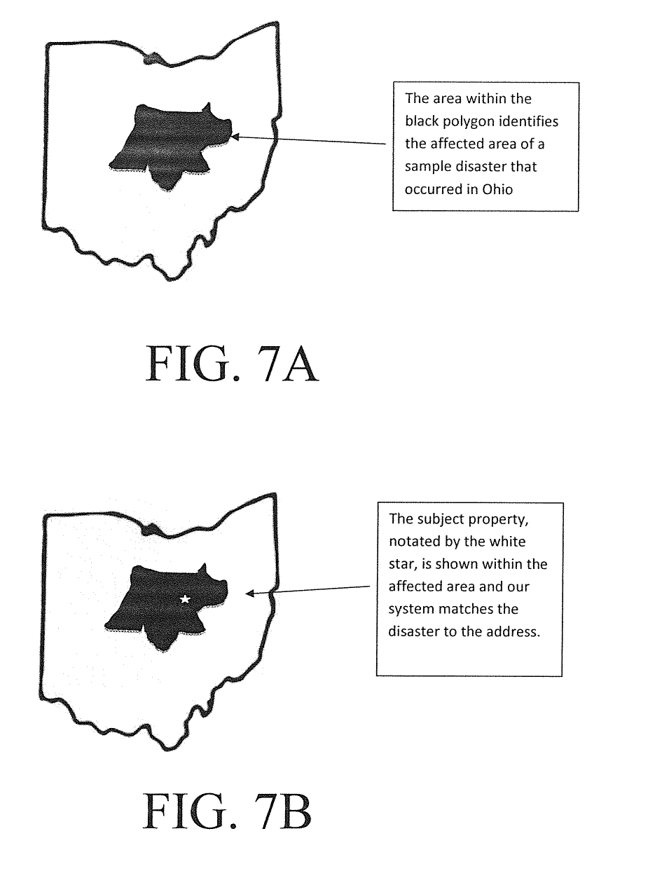

Referring now to FIG. 1, therein illustrated is an exemplary embodiment of the present invention of a method of providing a disaster alert notice report that may be used to inform an individual or entity with an interest or potential interest in a particular property, whether resident, commercial or industrial or events that could have damaged the property. In general, the disaster alert notice report prepared according to exemplary embodiments of the present invention provides a thorough, geographically precise and expedient alert of events that could have damaged the property at the specific address and/or location of the property. The disaster alert notice report is provided in response to an inquiry that includes the property address or location of the property and a date range to be searched for any relevant disasters that may have affected the property. In response to the inquiry, a disaster alert notice system searches a disaster database prepared and maintained according to the invention and determines if any disasters occurred in the property's geographic area that might have affected the property. If so, the details for those disasters are provided in the disaster alert notice report. FIG. 7B provides an illustrated example of the method according to the present invention. In FIG. 7B, the subject property is found to be within a defined disaster area, and accordingly the disaster alert notice report would provide an indication that the disaster associated with the disaster area may be relevant with respect to the subject property.

Referring again to FIG. 1, the exemplary embodiment of the method for providing the disaster alert notice more particularly includes a step 10 of receiving login information from a customer. The login information may be in the form of an xml request, and placed through a website or from a loan origination system or similar software. The customer desiring to receive a disaster alert notice, may be an individual or an entity, such as a company, and may provide the login information from any internet enabled device, such as a computer, mobile device or tablet. Once the login information is received, the method further includes receiving either an individual or a batch order in a step 15. An individual order pertains to a single property, and the single property's address is entered by the customer in a step 20. The address may be entered as any location identifying information, such as street address and town/city or as latitudinal and longitudinal coordinates. A date range from which to search for disasters, including a start date and an end date, may then be selected in a step 25, and in a step 30 the types of disasters that are desired to be included in the disaster alert notice may also be identified, preferably each type of disaster may be selected individually or if all disaster types are desired then an option for selecting all disaster types may be presented to the customer. Once the property location identifying information, date range and disaster types are entered the order is submitted and received in a step 35. The order is processed when received in order to assign a geographic code, which may represent a particular geographic area that contains the location of the property, to the property based on the location identifying information of the property in a step 40. In this manner, the address of the property is standardized and geocoded so that a geographic area in which the property is located can be searched for disasters occurring during the date range provided in a step 45. In step 45 both the address of the property and the geographic code assigned to the property are cross-referenced against any disaster areas defined in a disaster database. If the address and/or geographic code are found to be within one or more disaster areas during the specified date range, the disaster details for each of the disaster areas will be provided in the disaster alert notice report in a step 50. In a step 55 the disaster alert notice report is provided to the customer via a website or other electronic delivery means. It is also contemplated that the disaster alert notice report may be physically mailed to the customer or other interested parties via regular mail.

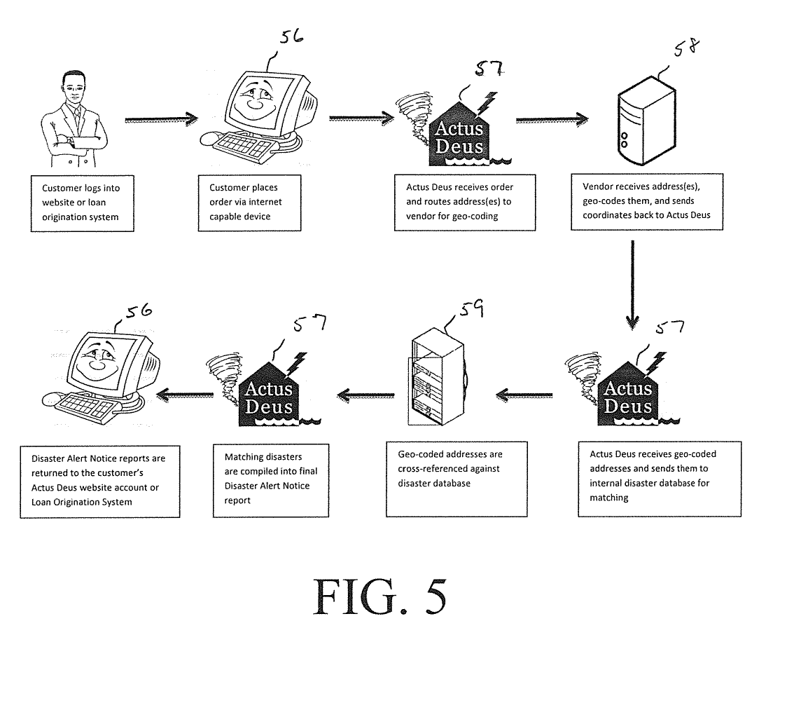

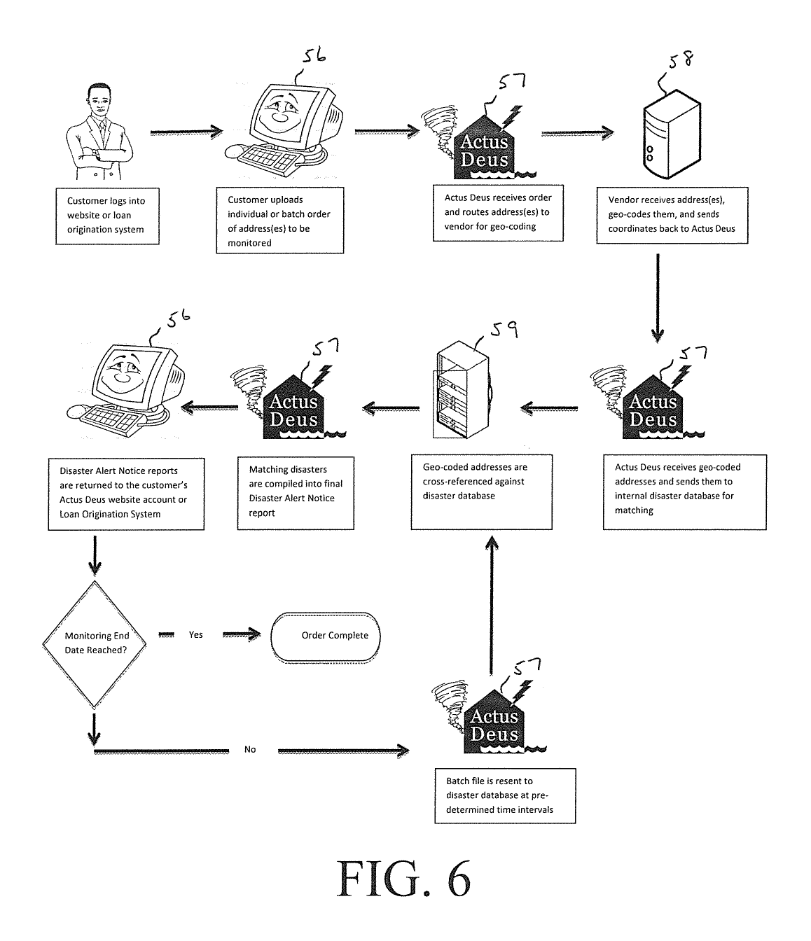

Referring now to FIGS. 5 and 6, the exemplary components that may be used to perform the various steps of the method discussed above with respect to FIG. 1 are shown. Any internet capable device 56, for example a computer, mobile device or tablet, receives an order from a customer for a disaster alert notice for one or more properties. The system 57, which may comprise appropriate computer program code, memory and processors, of the present invention then receives the order and either routes the order to a server 58 of an outside vendor for geocoding or geocodes the address or addresses itself. The geocoded address or addresses are then transferred to a disaster database contained on a computing device 59 in order to cross-reference the geocoded addresses against the disasters within the disaster database that may be relevant to the subject property or properties. These disasters are then transferred to the system 57 for compilation into the disaster alert notice report, and then transfer, for example via the website, email, or xml to the internet capable device 56 of the customer. If continuous monitoring is ordered, as discussed further below with respect to FIG. 1, then the geocoded files of the subject property or properties is resent from the system 57 to the computing device 59 containing the disaster database at predetermined intervals in order to determine whether any additional disasters should be included in a subsequent disaster alert notice report to be provided prior to the end of the selected monitoring period. It is understood that while separate components are shown in the above exemplary embodiment of the invention, it is contemplated that the components, whether hardware or software, may be integrated into one or more systems and do not necessarily need to be separate components. For example, the computing device 59 may be included directly within the system 57, for example as a memory storage device containing the disaster database.

Referring again to FIG. 1, an alternative exemplary embodiment of the present invention of providing a disaster alert notice report regarding more than one property includes a step 60 of preparing a spreadsheet or other data file that includes more than one property address. Next the method may also include a step 65 of selecting a one-time review or continual monitoring of disasters over a specified period of time. If one-time review is selected, then the method proceeds to step 25 as discussed above. If continual monitoring is selected, then in a step 70 a monitoring end date is selected, and then the method proceeds to step 30 as discussed above. When continual monitoring is selected the selected property addresses are continually cross-referenced at predetermined intervals until the monitoring end date in the disaster database in order to find any newly added disasters to the disaster database that could potentially be relevant to the property or properties. In this manner, disaster alert notice reports are provided whenever a disaster occurs that could potentially affect any of the properties. It is understood that while not specifically discussed above, the present invention contemplates that continual monitoring can be employed with respect to a single property, and multiple properties are not required to perform continual disaster monitoring during a period of time.

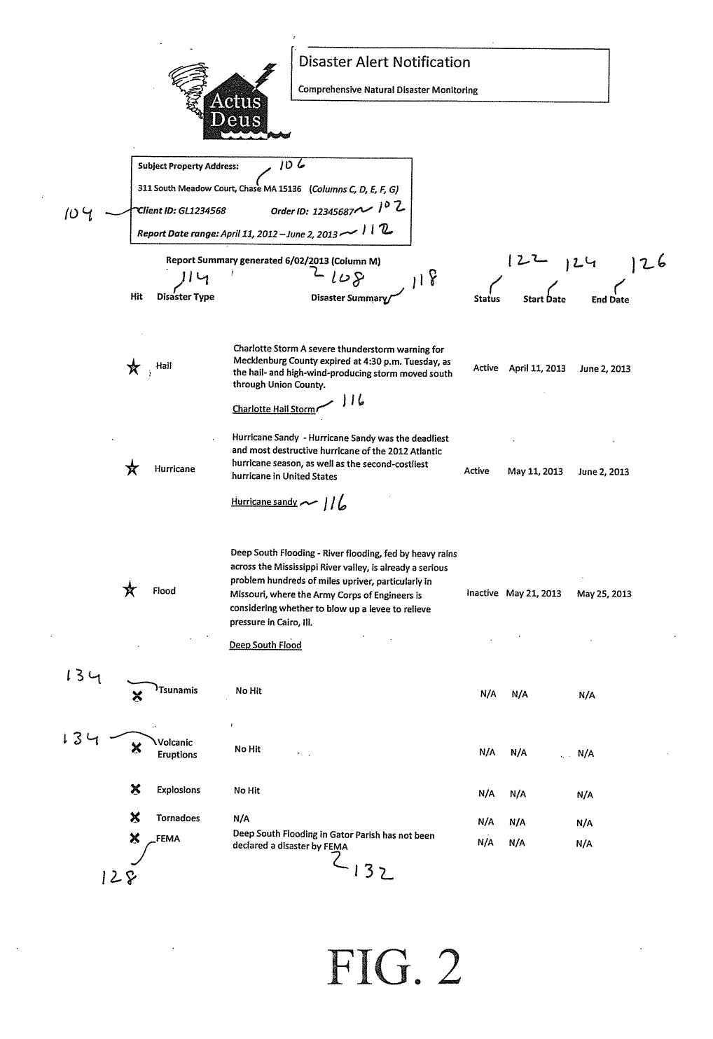

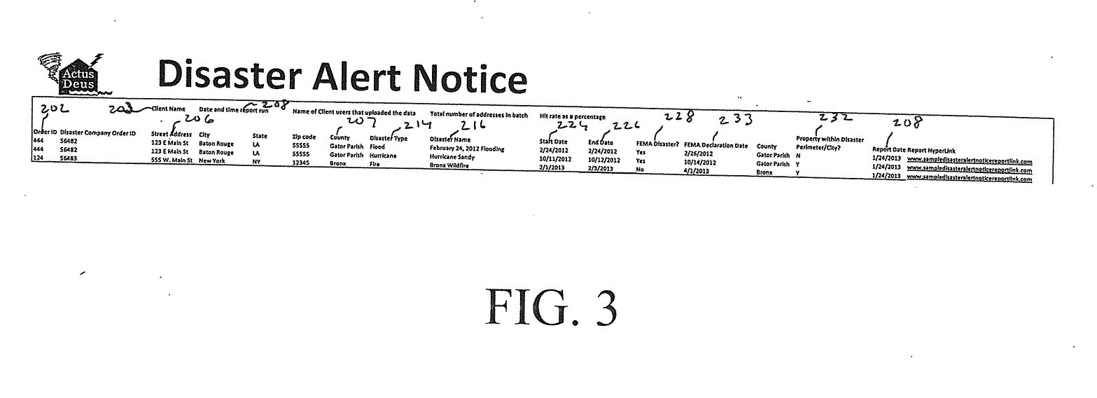

Referring now to FIGS. 2 and 3, therein illustrated are exemplary examples of disaster alert notice reports that may be prepared and provided according to exemplary embodiments of the present invention. FIG. 2 represents a disaster alert notice report with respect to a single property, and FIG. 3 demonstrates an example of a disaster alert notice report for batch order having multiple addresses ordered all at once. The disaster alert notice report is essentially the data that is provided to the customer for a selected property, address and date range, and may generally returned in PDF format (FIG. 2), as a spreadsheet (FIG. 3) or in xml format (not shown), however it is understood that other formats and delivery options may also be utilized.

Referring particularly to FIG. 2, an exemplary disaster alert notice report may include, but is not limited to, a Customer's Order Identification 102, e.g. a file number. The Customer's Order Identification 102 can be useful but is not essential to the disaster alert notice report. The disaster alert notice report may also include a Customer's Client Identification 104, which may also be useful for processing and billing but not essential to the disaster alert notice report. The disaster alert notice report may also include the selected Subject Property Address 106, the standardized address of the subject property (not shown), which may include the county of the address, the latitude and longitude coordinates of the subject property (not shown), the date 108 the disaster alert notice report was prepared, the date range 112 that the customer specified to be included in the disaster alert notice report, the disasters that occurred in the geographical areas and date range matched the subject property, namely Disaster Type 114, Disaster Name 116, Disaster Summary 118, link(s) to news stories and press coverage (not shown), a status 122 of the disaster, i.e. whether the disaster is considered to be active or inactive, a Disaster Start Date 124 and a Disaster End Date 126. The disaster alert notice report may also include Federal Emergency Management Agency (FEMA) details 128 on all disasters that matched the subject property and date range, including whether FEMA declared this disaster and the property is/is not in the disaster area as defined by other sources 132, and FEMA Dates (not shown), including a FEMA Start Date, i.e. the date that FEMA states the disaster started, a FEMA End Date, i.e. the date that FEMA states the disaster ended, a FEMA Declaration Date, i.e. the date that FEMA declared that specific area a disaster, and link(s) to a FEMA disaster story (not shown). The disaster alert notice report may also include disaster types searched that did not have a match with the subject property 134.

Referring now particularly to FIG. 3, an exemplary disaster alert notice report for multiple properties may include, but is not limited to, a Customer's Order Identification 202, e.g. a file number. The Customer's Order Identification 202 can be useful but is not essential to the disaster alert notice report. The disaster alert notice report may also include a Customer's Client Identification, such as a client name 203 and which may also be useful for processing and billing but not essential to the disaster alert notice report. The disaster alert notice report may also include the selected Subject Property Addresses 206, the standardized address of the subject property (not shown), which may include the county of the address 207, the latitude and longitude coordinates of the subject property (not shown), the date 208 the disaster alert notice report was prepared, the date range (not shown) that the customer specified to be included in the disaster alert notice report, the disasters that occurred in the geographical areas and date range matching the subject property, namely Disaster Type 214, Disaster Name 216, Disaster Summary (not shown), link(s) to news stories and press coverage (not shown), a status (not shown) of the disaster, i.e. whether the disaster is considered to be active or inactive, a Disaster Start Date 224 and a Disaster End Date 226. The disaster alert notice report may also include Federal Emergency Management Agency (FEMA) details 228 on all disasters that matched the subject property and date range, including whether FEMA declared this disaster and the property is/is not in the disaster area as defined by other sources 232, and FEMA Dates (not shown), including a FEMA Start Date, i.e. the date that FEMA states the disaster started, a FEMA End Date, i.e. the date that FEMA states the disaster ended, a FEMA Declaration Date 233, i.e. the date that FEMA declared that specific area a disaster, and link(s) to a FEMA disaster story (not shown).

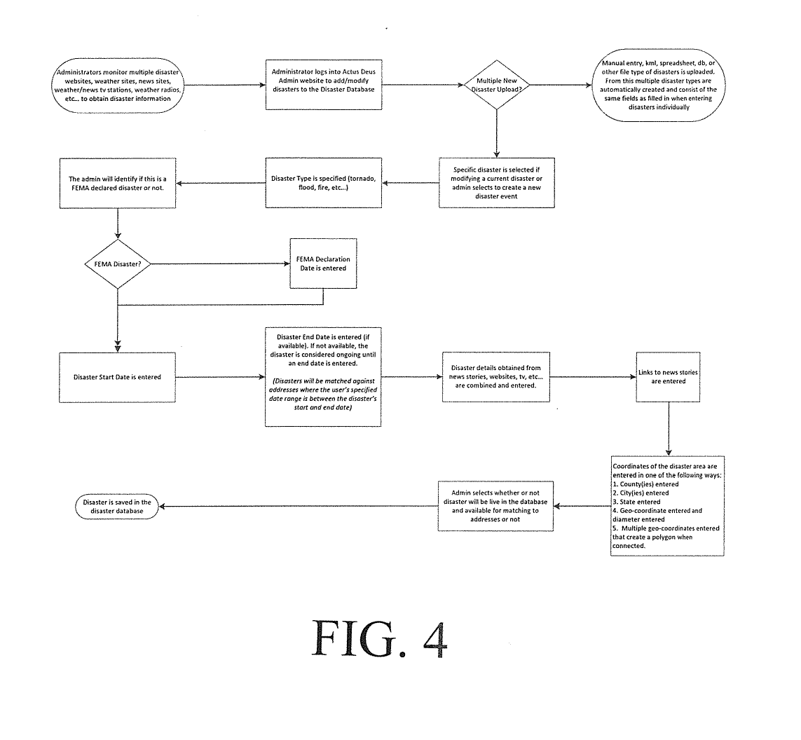

The present invention also contemplates the creation and maintenance of a disaster database that is used to search for disasters that may be related to at least one property of interest. The disaster database is maintained as a collection of current and historical disasters. The maintenance of the disaster database is shown generally in FIG. 4, in which disasters are added to or modified in the disaster database. As new disasters occur, the new disasters are identified and entered into the disaster database. Both manually and search modes are contemplated for identifying disasters. For example, disaster information may be collected using a variety of public and private data sources, government, local, and national news sources. Each disaster is selected as either “active” meaning that the disaster is live in the system and available to be matched up against orders or “inactive” meaning the disaster is not live in the system and unavailable to be matched up against orders. The inactive status may be used when partial information on a disaster is available, with the assumption that the rest of the information will be added when it is available and the disaster will then be made “active.” Historical disasters are maintained in the database for an extended period to cover the possibility of unrepaired past damage and can be filtered to a date range specified by the user.

Information entered into or modified within the disaster database includes but is not limited to, disaster type, disaster name, disaster start date, disaster end date, news stories and other press coverage, links to news stories, a disaster area, and FEMA Details, such as FEMA start date, FEMA end date, FEMA declaration date, FEMA news stories and other press coverage and FEMA disaster area. The disaster types that may be included in the disaster database include, but are not limited to hurricanes/typhoons, tornadoes/water spouts, hail, high winds/micro bursts, floods whether natural or man-made, fires, volcanic eruptions, explosions, earthquakes, tsunamis, chemical spills, such as oil spills, any other disaster or event that could potentially damage property or any combination thereof. The disaster area defined for each disaster entered into the disaster database may include one or more of the following in order to define the area that may have been affected by the disaster, city/town, zip code, county, state, contiguous combinations thereof, multiple latitude and longitude coordinates that when connected create a disaster perimeter, as shown for example in FIG. 7A, or a specific central latitude and longitude coordinate with a diameter applied to it, creating a circle defining the disaster area. It is understood that multiple latitude and longitude coordinates defining multiple circles may be created and then joined together forming a disaster path for the disaster area.

It is understood that the exemplary embodiments of the present invention may be implemented by a variety of combinations of hardware and/or software components, for example the embodiments of the present invention may be implemented by an apparatus that includes at least one processor and at least one memory including computer program code, where the at least one memory and the computer program code are configured to with the at least one processor to cause the apparatus to perform the exemplary embodiments of the methods of the present invention. It is further understood that the exemplary embodiments of the present invention may be implemented by a system of hardware and/or software components.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A method for indicating disasters affecting at least one property, comprising:
receiving a disaster inquiry comprising location information for the at least one property and a date range having a start date and an end date,
standardizing the location information for the at least one property to produce a geographic area for the at least one property,
searching a disaster database for at least one disaster occurring between the start date and the end date of the date range and within the geographic area for the at least one property, and
providing the disaster alert notice report identifying any disasters occurring within the date range and the geographic area for the at least one property.

2. The method according to claim 1, wherein the disaster database is searched at regularly scheduled intervals for at least one disaster occurring between the start date and the end date of the date range and within the geographic area for the at least one property, and
wherein the disaster alert notice report is provided at regularly scheduled intervals for disasters occurring within the date range and the geographic area for the at least one property.

3. The method according to claim 1, wherein the disaster database comprises at least one disaster selected from hurricanes, tornadoes, hail, high winds, flooding, fires, volcanic eruptions, explosions, earthquakes, tsunamis, chemical spills, any other events that may damage property or any combination thereof and a disaster area associated with each of the at least one disasters.

4. The method according to claim 3, wherein the disaster area associated with each of the at least one disasters is a geographic identifier selected from a city/town, a zip code, a county, a state, contiguous combinations thereof, a disaster perimeter comprised of multiple latitude and longitude coordinates, a distance diameter applied to a specific latitude and longitude coordinate or any combination thereof.

5. The method according to claim 1, wherein the disaster alert notice report comprises the location information for the at least one property, the geographic area for the at least one property, a latitude and longitude coordinate for the at least one property, a date identifier for the disaster alert notice report, the date range, an identification for each disaster identified in the disaster alert notice report and Federal Emergency Management Agency information for each disaster identified in the disaster alert notice report.

6. The method according to claim 5, wherein the identification for each disaster comprises a disaster type, a disaster name, a disaster summary, press coverage of the disaster, a disaster start date and a disaster end date.

7. The method according to claim 5, wherein the Federal Emergency Management Agency information for each disaster comprises a disaster area, a disaster date range comprising a disaster start date and a disaster end date and a disaster declaration date.

8. The method according to claim 1, wherein the disaster database comprises a collection of disasters, and the method further comprises compiling the collection of disasters by adding each disaster to the collection of disasters, and wherein the disaster database includes a disaster type, a disaster name, a start date, an end date, press coverage, a disaster area and Federal Emergency Management Agency information for each disaster of the collection of disasters.

9. The method according to claim 8, further comprising adding an additional disaster to the collection of disasters of the disaster database.

10. The method according to claim 8, further comprising providing either an active indication or an inactive indication for each disaster of the collection of disasters, wherein only disasters having an active indication are searched for between the start date and the end date of the date range and within the geographic area for the at least one property.

11. An apparatus for indicating disasters affecting at least one property, comprising:
at least one processor and at least one memory including computer program code, wherein the at least one memory and the computer program code are configured to with the at least one processor to cause the apparatus to receive a disaster inquiry comprising location information for the at least one property and a date range having a start date and an end date,
standardize the location information for the at least one property to produce a geographic area for the at least one property,
search a disaster database for at least one disaster occurring between the start date and the end date of the date range and within the geographic area for the at least one property, and
provide the disaster alert notice report identifying any disasters occurring within the date range and the geographic area for the at least one property.

12. The apparatus according to claim 11, wherein the disaster database is searched at regularly scheduled intervals for at least one disaster occurring between the start date and the end date of the date range and within the geographic area for the at least one property, and
wherein the disaster alert notice report is provided at regularly scheduled intervals for disasters occurring within the date range and the geographic area for the at least one property.

13. The apparatus according to claim 11, wherein the disaster database comprises at least one disaster selected from hurricanes, tornadoes, hail, high winds, flooding, fires, volcanic eruptions, explosions, earthquakes, tsunamis, chemical spills, any other events that may damage property or any combination thereof and a disaster area associated with each of the at least one disasters.

14. The apparatus according to claim 13, wherein the disaster area associated with each of the at least one disasters is a geographic identifier selected from a city/town, a zip code, a county, a state, contiguous combinations thereof, a disaster perimeter comprised of multiple latitude and longitude coordinates, a distance diameter applied to a specific latitude and longitude coordinate or any combination thereof.

15. The apparatus according to claim 11, wherein the disaster alert notice report comprises the location information for the at least one property, the geographic area for the at least one property, a latitude and longitude coordinate for the at least one property, a date identifier for the disaster alert notice report, the date range, an identification for each disaster identified in the disaster alert notice report and Federal Emergency Management Agency information for each disaster identified in the disaster alert notice report.

16. The apparatus according to claim 15, wherein the identification for each disaster comprises a disaster type, a disaster name, a disaster summary, press coverage of the disaster, a disaster start date and a disaster end date.

17. The apparatus according to claim 15, wherein the Federal Emergency Management Agency information for each disaster comprises a disaster area, a disaster date range comprising a disaster start date and a disaster end date and a disaster declaration date.

18. The apparatus according to claim 11, wherein the disaster database comprises a collection of disasters, and the at least one memory and the computer program code are configured to with the at least one processor to further cause the apparatus to compile the collection of disasters by adding each disaster to the collection of disasters, and wherein the disaster database includes a disaster type, a disaster name, a start date, an end date, press coverage, a disaster area and Federal Emergency Management Agency information for each disaster of the collection of disasters.

19. The apparatus according to claim 18, wherein the at least one memory and the computer program code are configured to with the at least one processor to further cause the apparatus to add an additional disaster to the collection of disasters of the disaster database.

20. The apparatus according to claim 18, wherein the at least one memory and the computer program code are configured to with the at least one processor to further cause the apparatus to provide either an active indication or an inactive indication for each disaster of the collection of disasters, wherein only disasters having an active indication are searched for between the start date and the end date of the date range and within the geographic area for the at least one property.
